(19) United States
(12) Patent Application Publication
(10) Pub. No.: US 2012/0211308 A1
(43) Pub. Date: Aug. 23, 2012

(54) FORK FOR HANDLING EQUIPMENT

(76) Inventor: Eric Issartel, Vouneuil Sur Vienne (FR)

(21) Appl. No.: 13/502,513

(22) PCT Filed: Oct. 23, 2010
(86) PCT No.: PCT/IB10/54791

§ 371 Date: May 8, 2012

(30) Foreign Application Priority Data
Oct. 23, 2009 (FR) 0957461

(51) Int. Cl. B66F 9/12

(52) U.S. Cl. 187/237

(57) ABSTRACT

The invention relates to a fork for handling equipment, comprising: a fork arm extending along an arm axis (B), and a trigger (22) mounted on the fork arm such that it can rotate between inoperative and operative positions. The trigger comprises a distal trigger end (26) which, in the inoperative position, defines the distal end of the fork and the trigger is configured such that, when a pressure (FR) is exerted on the distal trigger end along the arm axis (B) in the direction of the fork arm, the trigger tilts from the inoperative position to the operative position.

### TECHNICAL FIELD

The present invention relates to a fork for a material handler, particularly for a forklift, and to a material handler equipped with such a fork.

### PRIOR ART

A forklift is a piece of material handling equipment intended for moving loads, in particular pallets, especially in factories and warehouse buildings. A forklift enables one in particular to pile pallets, in other words to stack one on top of the other, then, as needed, to unstack these pallets. Conventionally, unstacking pallets consists of the following operations:

Raising the carriage in such a manner as to align the is horizontal arms of the forks with the openings of the pallet;

Moving the forklift toward the pallet to insert the fork arms into the openings;

Raising the carriage so that the pallet is resting on the fork arms;

Reversing the forklift to pick off the pallet; and

Lowering of the carriage.

Perfect positioning of the horizontal fork arms opposite the pallet openings is necessary to prevent the forks from pushing the pallet when the forklift advances, which would make unstacking it more delicate at a later point.

A positioning error may also result in damaging the goods stored on the pallet, in particular by piercing their packaging. Resulting financial losses could be significant, in particular if these goods are finished products.

Therefore, there is a need for a material handler able to respond, at least partially, to the above-described problems.

### SUMMARY OF THE INVENTION

The invention is a fork for a material handler, in particular a forklift, comprising:

a fork arm extending along an arm axis, and

a trigger rotatably mounted on the fork arm between passive and active positions, the trigger having an outer end of the trigger defining in the passive position an outer end of the fork, and the trigger being configured in such a manner that a pushing force exerted on the outer end of the trigger, along the arm axis and toward the fork arm, pivots the trigger from the passive position to the active position.

As will be seen in greater detail after the description, pivoting the trigger enables signaling of the presence of an obstacle interfering with advance of the fork, and therefore signals improper vertical positioning of this fork.

The shape and the dimensions of the fork are not limiting. However, preferably, they correspond to the standards required for the handling of pallets, in particular “Euro” or “ISO” type pallets (120 cm/80 cm; NF EN 445, ISO 8611, NF EN 13698, and NF EN 13382).

Preferably in the passive position the trigger does not protrude radially, relative to the arm axis, beyond the fork arm. In other words, if one were to virtually extend the exterior face of the fork arm toward the outer end of the fork in such a manner as to define an envelope, the trigger would be located within this envelope. Advantageously, it would therefore not impede normal use of the fork. Preferably, the trigger is designed in such a manner that in the passive position the general shape of the assembly constituted by the fork arm and trigger is that of a fork arm of the same type not equipped with a trigger.

In the passive position, the trigger may be approximately horizontal after mounting the fork on a material handler.

To prevent the trigger from moving out of the passive position unintentionally, the trigger is preferably maintained in a passive position in the absence of the pushing force, for example by friction and/or electromagnetism and/or by a fastener or tie and/or by sticking and/or by its weight or by a counterweight and/or by an elastic body, for example a spiral spring or a spring clip. The passive position corresponds preferably to a stable balanced position.

The pushing force causing pivoting of the trigger from its passive position to an active position may generate on the trigger a moment where the lever arm is in the passive position greater than 1 mm, preferably greater than 5 mm and/or less than 30 mm, less than 20 mm, less than 15 mm, or even less than 10 mm.

Preferably also, a pushing force greater than 100 N, preferably greater than 50 N, preferably greater than 10 N is sufficient to pivot it.

Pivoting from the passive position to the active position may force the outer end of the fork above or below a central horizontal plane of the fork arm.

The active position is offset angularly from the passive position, in terms of an absolute value, by more than 45°, by more than 60°, and by more than 80°.

The angular travel between the active and passive positions may be approximately 90°, in particular when the outer end of the trigger pivots below the horizontal central plane of the fork arm.

An angular spread less than 90° may place the trigger in an unbalanced condition in the active position when the pushing force stops, in particular when the outer end of the trigger pivots above the horizontal central plane of the fork arm. The trigger may thus have a tendency to fall back, under the effect of its own weight, to the passive position (see FIG. 5, for example)

Preferably, the fork has stops preventing rotation of the trigger beyond the passive and active positions. These stops may in particular be formed by the fork arm.

Preferably, the axis of rotation of the trigger on the fork arm is perpendicular to the arm axis, in other words the normal planes of these axes intersect at right angles. These axes may or may not be coplanar. However, to create the lever arm necessary so that the pushing force along the arm axis makes the trigger pivot from the passive position to the active position, the straight line passing across the outer end of the trigger and parallel to the arm axis must not be coplanar to the axis of rotation of the trigger.

To make pivoting easier, the outer end of the trigger may have, in a vertical cross-sectional plane, a rounded profile and/or comprise an antifriction surface and/or be equipped with at least one roller, preferably mounted to freely rotate, preferably parallel to the axis of rotation of the trigger on the fork arm.

There is an outer part of the trigger, extending from the outer end of the trigger to the axis of rotation of the trigger, and an inner part of the trigger extending from this axis of rotation to the inner end of the trigger. The outer part of the trigger may have a maximum thickness greater than 1 cm, greater than 1.5 cm and/or less than 7 cm, less than 5 cm, less than 4 cm, less than 3 cm, and/or a maximum width greater than 2 cm, greater than 5 cm, greater than 7 cm and/or less than 15 cm, and/or a maximum length greater than 5 cm and/or less than 30 cm, less than 20 cm, less than 10 cm.

The outer end of the trigger may have the same maximum width and/or same maximum thickness as the fork arm. The thickness and/or the width of the outer end of the trigger may be approximately constant. In one embodiment, at least near the axis of rotation of the trigger, the transverse section of the outer part of the trigger is approximately identical to that of the fork arm. Preferably, the outer end of the trigger lies approximately within an axial extension of the fork arm. For example, with a fork arm having a rectangular transverse section, the outer end of the trigger has lateral, top, and bottom sides that are coplanar with the corresponding sides of the fork arm, at least in the proximity of the axis of rotation of the trigger.

The use of a counterweight and/or an elastic body to hold the trigger in the passive position in the absence of the pushing force advantageously allows the trigger to be brought back to a passive position after the pushing forced has ceased without any human intervention in this regard.

When the trigger is actuated by the pushing force so that the pushing force causes the outer part of the trigger to pivot downwardly, the inner part of the trigger may in particular form a counterweight generating a return torque toward the passive upper position at the moment generated by the weight of the outer part of the trigger, tending to bring it into the active position. After activating the trigger, return to a passive position is immediate and requires no human intervention. The number of parts of the fork is also advantageously low.

The trigger may be mounted to rotate freely on the fork arm. Rotation may also be impeded by an elastic body, for example a spring tending, like the counterweight mentioned above, to permanently bias the trigger toward the passive position.

The trigger may be of a material that is identical or different from that of the fork arm, for example of steel or spark-free alloy for use in flammable atmospheres.

Preferably, the surface area of the trigger's normal projection along the arm axis in the active position is at least two times, at least three times, at least five times, and even at least ten times greater than the surface area of the normal projection in the passive position. An angular spread of approximately 90° between the passive and active positions allows one, in one embodiment, to maximize the ratio between these two projecting surfaces.

As will be seen later in greater detail after the description, the trigger thus has a reduced frontal surface area in the passive position, facilitating penetration into the openings of the pallet and has, in the active position, a higher frontal surface area limiting the risk of puncturing goods. In addition, increasing resistance to the forward movement of the fork in the active position may serve as a vertical position error signal for the fork.

The trigger may comprise a face that, in the active position, defines a front-facing surface at the outer end of the fork arm. This face may in particular be a face that in the passive position constitutes a top or bottom side of a plate. The surface area of this face may be greater than 10 cm², greater than 15 cm², greater than 20 cm², and even greater than 30 cm², greater than 40 cm², and even greater than 50 cm². Advantageously, such a configuration allows one to substantially increase the normal projection of the trigger along the arm axis when pivoted in an active position.

In another embodiment, the fork does not comprise a specific trigger pivoting sensor, and in particular no electric sensor. Preferably also, the fork arm, or the fork, has no electric parts. The trigger thus constitutes a mechanically simple and reliable means that may be used in any environment, in particular an explosive one or for implementation in flammable atmospheres.

In another embodiment, the fork arm may comprise a specific trigger-pivot sensor. In particular, it may comprise a strain gauge arranged in such a manner that it is compressed when pivoted into the active position and/or a switch arranged so as to change position on pivoting. The sensor may be connected electrically to a controller capable of interpreting information supplied by the sensor and take action accordingly, in particular to warn users of the handler and/or to modify the operation of the handler, for example by stopping its forward movement. In particular, the controller may be capable of illuminating a light indicator and/or emitting an audio signal.

Preferably, the fork and/or the forklift has a reader that can read from a distance a label made legible at the time of pivoting. The reader may be for example a barcode reader. The label may be a barcode or an RFID code arranged on the bottom side of the trigger in such a manner that when the trigger pivots, the label enters into the field of the reader. The arrangement of the label on the bottom side of the trigger advantageously allows the label to be protected in the passive position.

The trigger may be mounted directly on the fork arm or by a support fixed rigidly on the fork arm. The invention also relates to a support on which is rotatably mounted a trigger and able to be fixed rigidly on a fork arm in such a manner as to constitute a fork according to the invention.

The support may in particular have the shape of a sleeve in which a fork arm may be inserted. Preferably, the sleeve has a shape approximately complementary to that of the fork arm on which it is mounted so as to limit play. For example the sleeve may have the shape of sleeves conventionally used to affix fork extensions. The support may have a bottom or more generally a stop, allowing one to precisely define the position of the support along the arm axis.

All of the means for mounting the support on the fork arm may be considered. Preferably, the trigger has a body and a roller mounted to rotate freely on the body, the roller defining the outer end of the fork.

The invention also relates to a material handler having at least one fork according to the invention.

The handler may be selected from all the handlers having one or more forks. In particular, it may be selected from a forklift (front or lateral), a stacker, a pallet truck, and a device with telescopic arms. The handler may be manual or not, or even mixed.

In an embodiment, all the forks of the handler conform to the invention. The number of forks may in particular be two.

The invention also relates to a load-handling procedure by a handler according to the invention, the load being provided with at least one opening configured so that a fork arm of the handler can be inserted in it, the number of openings being greater than or equal to the number of forks.

Lastly, the invention relates to a vertical positioning error detection method of the fork of a handler, in particular of a forklift, a method in which one detects a change in position of a trigger mounted at the end of the fork arm, rotatable relative to the fork arm and able to pivot under the effect of a pushing force exerted along the axis of the fork arm toward the rear of the material handler.

Definitions

The terms “vertical,” “horizontal,” “high,” “low,” “top,” and “bottom” are defined relative to a situation in which the fork arm is approximately horizontal, which constitutes the most frequent position of the fork arm when in operation.

The “outer” and “inner” ends of a body correspond to the most distant ends and the closest ones to the base of the fork respectively.

Unless indicated otherwise, “comprising a” shall be understood as “comprising at least one.”

### BRIEF DESCRIPTION OF THE DRAWINGS

Other characteristics and advantages of the invention will been seen from the description and the attached drawings:

FIG. 1 is a perspective view of a typical forklift;

FIGS. 2, 4 and 5 schematically show, in a perspective view for FIG. 2 and in a central vertical cross section for FIGS. 4 and 5, examples of a detail of a fork according to the invention, in a passive position, and for FIGS. 4 and 5, in dashed lines, in the active position;

FIGS. 3a to 3c show different positions taken by the trigger of the fork shown in FIG. 2 in the event of a vertical positioning error of the fork;

FIGS. 6 to 10 show different embodiments for retrofitting a conventional fork to make it conform to the invention, in a preferred embodiment;

FIG. 11 shows an intermediate position between the passive and active positions of the trigger of the fork shown in FIG. 10;

FIG. 12 shows, in a perspective view, a trigger equipped with means to facilitate its pivoting;

FIG. 13 shows, in a perspective view, a fork arm able to is receive a trigger ; and

FIGS. 14a-14d show different embodiments of antisnagging measures in a central horizontal (FIGS. 14a-14c) or a vertical cross section (FIG. 14d). In the various drawings, identical references are used to describe identical or similar bodies.

### DETAILED DESCRIPTION

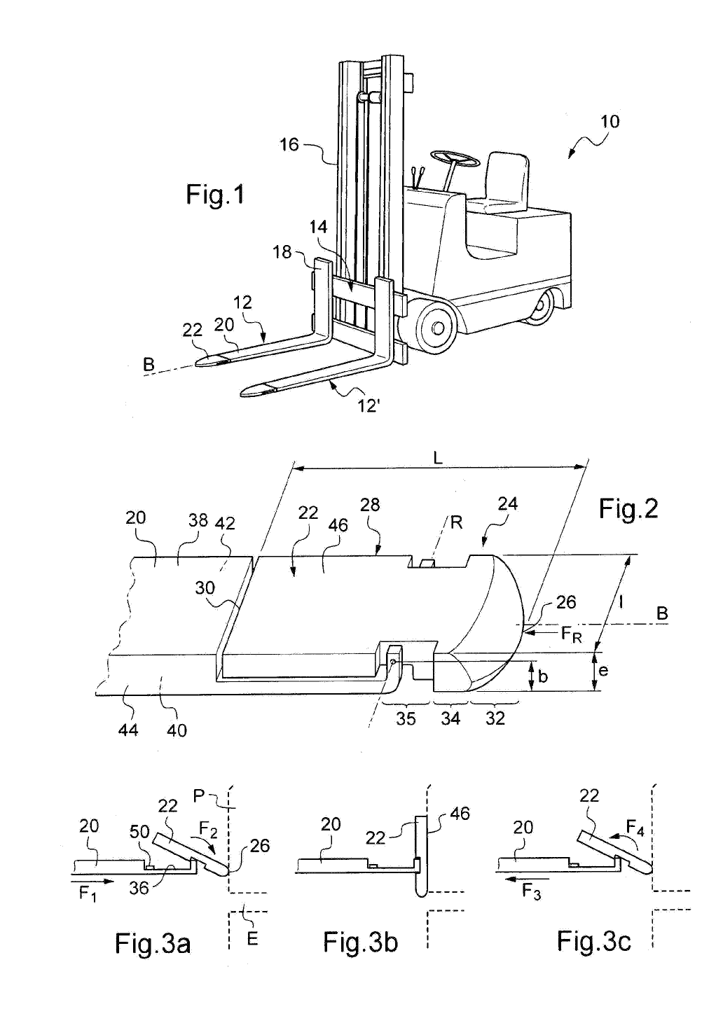

FIG. 1 shows a forklift 10 having two metal forks 12 and 12′ mounted on a carriage 14 vertically displaceable along a mast 16.

The forks 12 and 12′ being identical, only the fork 12 will be described.

The fork 12, which is L-shaped, comprises an approximately vertical base 18 fixed to the carriage 14, and an approximately horizontal fork arm 20 having an arm axis B whose free, tapered end is equipped with a trigger 22.

Reference is now made to FIG. 2, showing in greater detail this free end, the trigger being in a passive position.

The trigger 22 is mounted to rotate freely about an axis R of rotation on the fork arm. It has an outer part 24 extending from an outer end 26 to a transverse plane passing through the rotation axis R, and an inner part 28 extending from the transverse plane to an inner end 30.

The outer end 26 constitutes in the passive position the outer end of the fork arm.

The outer part 24 has at its outer end an outwardly gradually tapered part 32 enabling the insertion into openings of pallets, an intermediate part 34 of the same cross section as of the fork arm, and then a part [35] with a smaller width to enable rotation of the trigger 22.

In a central vertical cross-section of the fork arm (including the arm axis B), the tapered part comprises, in regard to the outer end 26, a rounded shape enabling pivoting of the trigger in a clockwise direction when subjected to a force Fᵣ along the arm axis B and toward the base 18 of the fork.

The inner part 28 has the shape of a plate recessed in a flat cavity 36 at the end of the fork arm.

All the dimensions are determined in such a manner that in the passive position, the trigger extends as an extension of a top side 38, bottom side 40, left side 42, and right side 44 of the fork arm.

In FIG. 2, the maximum thickness, the maximum width, and the maximum length of the trigger 22 are labeled “e”, “l” and “L,” respectively.

The top face 46 of the trigger has a top surface area of 10 cm².

When the fork is in use, the trigger 22 is, by default, in the passive position shown in FIG. 2.

In the event of an incorrect vertical positioning of the fork, the fork arm is not opposite an opening E of a pallet P, as shown in FIG. 3a. When the forklift moves toward the pallet P (arrow Fl), the outer end 26 of the trigger 22 enters into contact with the pallet P, then, under the effect of the pushing force Fᵣ exerted by the pallet P in reaction to the forward movement of the forklift, parallel to the arm axis B, pivots clockwise (arrow F₂). The lever arm b corresponds to the distance between the horizontal plane in which the rotation axis R extends and the horizontal axis of the force F_{R}. Under the effect of this moment, the trigger 22 pivots as the fork arm continues its forward movement toward the pallet P. If the operator of the forklift 10 is not aware of pivoting of the trigger 22, the rotation continues until reaching the active position, shown in FIG. 3b, in which rotation of the trigger is stopped by the stop on the fork arm.

In this position, the trigger 22 extends approximately vertically and has a front face, defined by its top side 46, which enables it to efficiently oppose the continued advancing of the forklift 10. This opposition may be translated by a displacement of the pallet P or, alternatively, by the impossibility to move the forklift 10 forward. The operator then becomes aware of the positioning error and backs up the forklift 10 (arrow F3), as shown in FIG. 3c. Under the counterweight effect exerted by the inner part 28, the trigger 22 returns to the passive position (arrow F4) as the forklift 10 backs up. The moment exerted by the weight of the inner part 28 is greater than that exerted by the outer part 24, in such a manner that return to a passive position is possible without any external application of force.

Rotation is stopped in the passive position by the stop of the inner part 28 on flat plate 36.

After the trigger 22 returns to the passive position, the operator can immediately modify the vertical position of the fork and make another attempt.

So that the positioning error can be rapidly detected, a sensor 50, for example electric, may be provided to detect all deviations of the trigger 22 from the passive position. The operator, warned for example by a light or audio signal, may then take action before the fork has begun to push on the pallet P. Detection by a sensor 50 also enables one to automatically modify the operation of the forklift 10, for example by immediately stopping its forward movement toward the pallet P.

The sensor may have the form of a switch actuated in such a manner that pivoting of the trigger causes a change in the position of the switch.

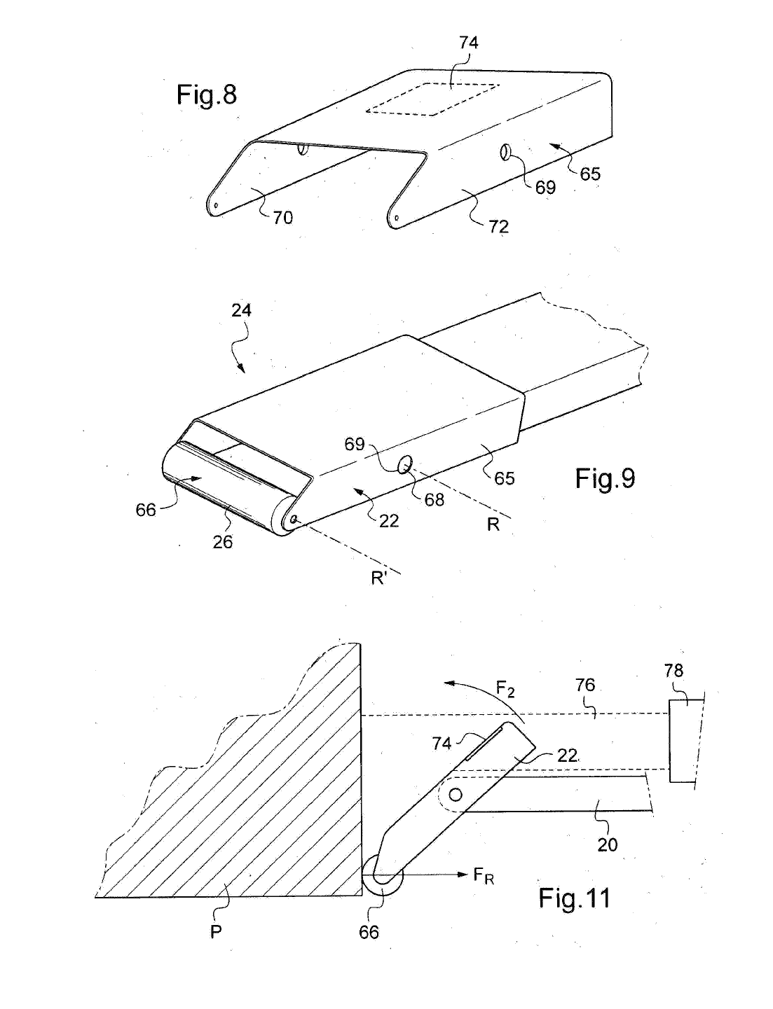

In an advantageous embodiment, it may comprise a label 74, for example in the form of a barcode label, a photo-electric reflector, or an RFID chip, as shown in FIGS. 8 and 11, this label interacting with a scanner 78 enabling reading from a distance, in other words without contacting the label.

In an embodiment, for example as shown in FIG. 8, the label is not exposed to the outside when the trigger 22 is in a passive position, for example, when it is on the bottom face of the trigger. In the passive position shown in FIG. 9, this label is thus protected.

The scanner 78, for example a barcode scanner, may have a scanning field, generally conical, whose axis extend approximately parallel to the fork arm. It may also in particular be mounted on the carriage 14 or on the base 18 of the fork. In a preferred embodiment, the label is arranged on the trigger in such a manner as to enter into a scanning field 76 of the scanner 78 when the trigger is pivoted from the passive position to the active position. Detection may take place when the active position is reached or in an intermediate position between the active and passive positions, which advantageously allows one to stop the forward movement of the forklift 10 before the fork has begun to push on the pallet P.

Now being described is a method enabling a conventional fork 20 to be retrofitted, as shown in FIG. 6, so that it can accommodate a trigger. To do this, an end part 60 of the fork 20 may be detached, for example by cutting the fork according to a transverse plane P_{c} (FIG. 6). A tube 62 may then be fixed, for example by a weld 64 on the arm 20. As will be subsequently seen, the tube 62 is serve as a bearing mount for pivoting of the trigger (FIG. 7).

Preferably, as shown in FIG. 9, the trigger 22 comprises a body 65 and a roller 66 mounted to freely rotate on the body 65 about an axis R′ approximately parallel to the axis R.

The body 65, shown in FIG. 8, may be a U-section profile for example.

The roller 66 extends approximately along the entire width of the trigger 22. The axis R′ is positioned in such a manner that the roller 66 can define the outer end 26 of the trigger 22.

The trigger 22 is rotatably mounted on the tube 62 by a rod 68 extending through the tube 62 and entering into holes 69 arranged in lateral flanges 70 and 72 of the body 65. As shown in FIG. 10, axis R′ is positioned on the body 65 in such a manner as to make a lever arm b allowing a moment to be created around the axis R by the force Fᵣ.

As shown in FIG. 11, in the event of improper positioning of the fork arm, the force Fᵣ exerted by the pallet P in response to forward movement of the forklift results in pivoting of the trigger (arrow F2) that, as explained above, results in the rapid detection of the positioning error. In this embodiment, the roller 66 may roll on the pallet P, which the rotation of the trigger 22 much easier.

In addition, this embodiment has the advantage of being very simple to manufacture, in particular by using U-section body 65 for the trigger.

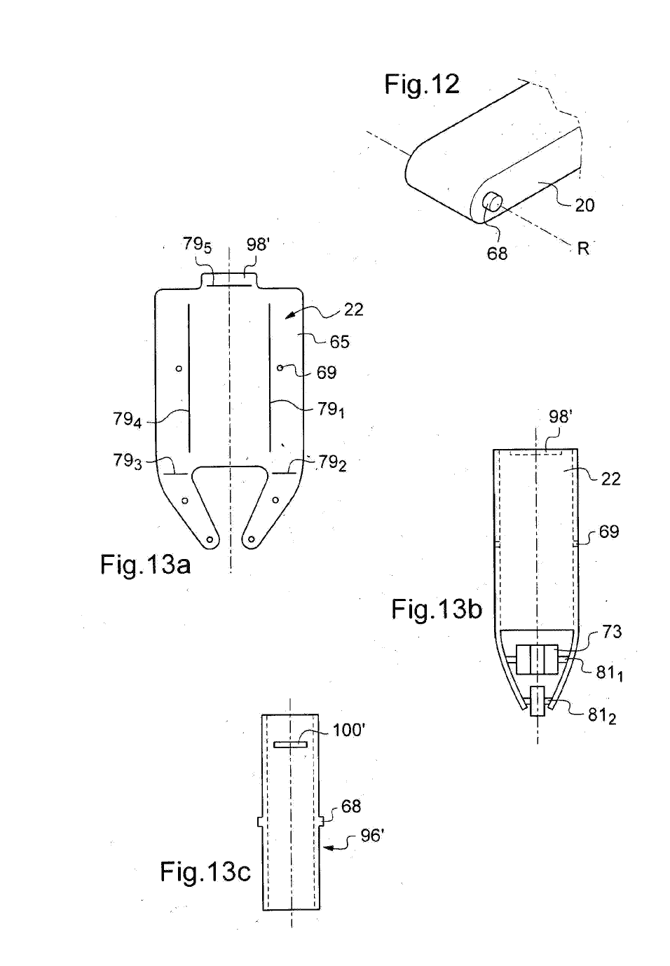

FIG. 12 shows a perspective view of the fork arm in the embodiment shown in FIG. 11.

By replacing the roller 66, or in addition to the roller 66, the trigger 22 may comprise one or more disks 73 mounted to rotate freely on the trigger (see FIG. 13b). The use of the disks is particularly well suited when the outer part of the trigger 22 is tapered.

Preferably, the end of the trigger has several axes carrying rollers and/or disks, for example approximately parallel to each other and extending preferably perpendicular to the longitudinal axis of the trigger, as shown in FIG. 13b (axis 81₁ and 81₂.

The thickness of each disk 73 may be, for example, less than 3 cm, less than 2 cm, even less than 1.5 cm and/or greater than 0.5 cm, a thickness of approximately 1 cm being well suited. Preferably, one adjusts the thickness of the disk 73 and/or roller and/or the number of disks to the space available. The use of a series of identical disks allows one to advantageously adapt to different shapes of the trigger using the same disks.

The trigger 22 shown in FIG. 13b may be made from a plate blank cut from sheet metal and having, for example, the form shown in FIG. 13a, the score lines being referred to as 79₁ to 79₅. Manufacture production of the trigger 22 is thus particularly quick and inexpensive.

In addition, the inventor observed that pivoting of the trigger may cause it to bind with the pallet P—a phenomenon known as “snagging.” Snagging may occur in particular when the fork arm is normally inserted into an opening of the pallet to be handled and the trigger strikes a part of the pallet causing it to cant in this opening. The trigger then pivots as the fork arm advances and its inner end 30 may engage with the pallet, preventing a return to a passive position. The user can thus no longer extract the fork without pulling back the pallet. The forklift's moving backward may thus unbalance the pallet.

To prevent this hazard, a fork according to the invention preferably comprises antisnagging means, in other words means allowing one to release the trigger and/or a trigger support, for example a sleeve, relative to the fork arm in the event of snagging. Preferably, the antisnagging means are designed in such a manner that a pulling force exerted on the trigger along the arm axis and toward the distant end of the trigger, releases the trigger or a trigger support (for example a sleeve) from the fork arm. “Releasing” refers to a detaching of the trigger and/or trigger support in such a manner that the trigger is no longer rigidly mounted on the fork arm.

To prevent the trigger from falling, the fork may have trigger-retention means in the event of release, for example a cable interconnecting the trigger and the fork arm.

Antisnagging means may comprise, for example, means for retracting or severing, under the effect of the pulling, an axis of rotation of the trigger on the fork arm.

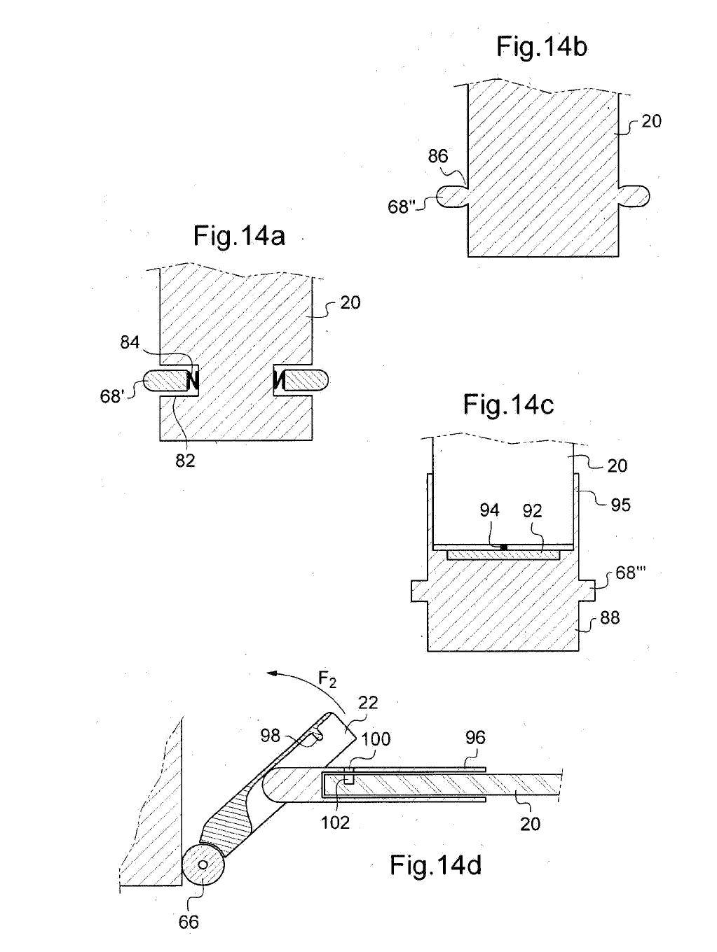

As shown in FIG. 14a, the antisnagging means may comprise pins 68′ mounted elastically on the fork arm so as to constitute the axis of rotation of the trigger. To this end, the pins 68′ are mounted in a sliding manner in housings 82 arranged in the fork arm. Springs 84 prevent the retraction of the pins 68′ into the housing 82, their stiffness being set to allow this retraction if a pulling force is exerted on the trigger corresponding to a snagging situation.

As a variant, as shown in FIG. 14b, pins 68″ of the trigger defining its axis of rotation may be breakable, and for example comprise a weakened region 86 that can break in the event of pulling corresponding to snagging. The weakened region may also be arranged elsewhere in regard to pins 68″, for example on a part of the fork arm. The weakened zone may also be replaced, for example, by magnets or clips, or any other deactivatable attachment means ensuring so that, if there is no snagging, the axis of rotation of the trigger or a part forming this axis remains attached to the fork arm.

Preferably, antisnagging means are not one-time use items and may be reset as in the embodiment of FIG. 12b or when using magnets, for example.

In the embodiment of FIG. 14c, part 88 of the fork arm bearing pins 68″ for rotation of the trigger is retained on the rest of the fork arm by a magnet 92 and/or an attachment 94. A sleeve 95 ensures the positioning of part 88. The antisnagging means may also comprise binding means, for example a bolt, holding the axis of rotation of the trigger bound to the fork arm in a passive position and deactivatable when pivoted.

As shown in FIG. 14d, the trigger may be rotatably mounted on a sleeve 96 fixed to the end of the fork arm by inserting a pin 98 into the trigger 22. The pin 98 is provided on the face of the trigger in contact with the sleeve 96 in the passive position. In the passive position, the pin 98 fits through an hole 100 in the sleeve and penetrates into a seat 102 of the fork arm, thus preventing any displacement of the sleeve 96 along the fork arm. If pivoted, as shown, the pin 98 comes out of the seat 102 and the hole 100, thereby permitting, in the event of snagging, the sleeve 96 to detach from the fork arm.

FIG. 13c shows a variant of the sleeve 96 from FIG. 14d, retrofitted to accommodate the trigger shown in FIG. 13b (made from the plate blank shown in FIG. 13a). The sleeve 96′ has a slot 100′ intended to receive a tab 98′ in the passive position. The sleeve 96′ is mounted on a fork arm equipped with a transverse groove in a position in which the transverse groove extends under the slot 100′. In the passive position, the tab 98′ fits through the slot 100′ and is inserted into the groove of the fork arm.

Preferably, the antisnagging means are only activatable when the trigger is not in a passive position and a pulling force, tending to spread the trigger from the fork arm, is exerted on its axis of rotation.

The trigger 22 may be rotatably mounted directly on the fork arm or by a sleeve 96 or 96′. In one embodiment, the use of a sleeve advantageously allows the mounting on a fork without modifying it.

The means to lock the sleeve on the fork are not limiting. In one embodiment, the sleeve may be disconnected from the fork arm in the event of snagging, as in the embodiment of FIG. 13c. The detachability of the sleeve in a snagging situation is particularly advantageous when the trigger cannot be released from the sleeve.

Preferably, the means attaching the sleeve to the fork arm are releasable in the event of snagging, as shown in the embodiment of FIGS. 13b and 13c described above.

Deactivatable attachment means may be implemented to attach the sleeve on the fork that comprise in particular friction means, for example an elastomeric material, a spring clip, or a cupped spring washer, for example mounted inside the sleeve, in particular in a reinforcement of the sleeve wall.

Preferably, the sleeve is constructed to avoid any pulling that could tend to release it except in a snagging situation. In particular, the thickness of the sleeve walls may be gradually reduced toward the rear of the sleeve, in other words toward the base 18 of the fork 12. The length of the sleeve may also be retrofitted so that the sleeve extends approximately over the entire length of the fork arm.

Preferably, the means to attach the sleeve (or more generally of the support of the trigger) on the fork arm do not require modifying the fork.

Obviously, the invention is not limited to the embodiments described and shown, which are provided for example purposes.

In particular, a fork according to the invention is not exclusively intended for handling a pallet and could be used in all applications in which a material handler is conventionally used, for example to lift barrels or bags. However, a fork according to the invention is poorly suited to be inserted under a load that is not equipped with holes cable of receiving fork arms. Such insertion, in terms of force, would have the effect of causing a pivoting of the trigger, thereby preventing the insertion.

In addition, the shape of the trigger is not limited to that shown in FIG. 2.

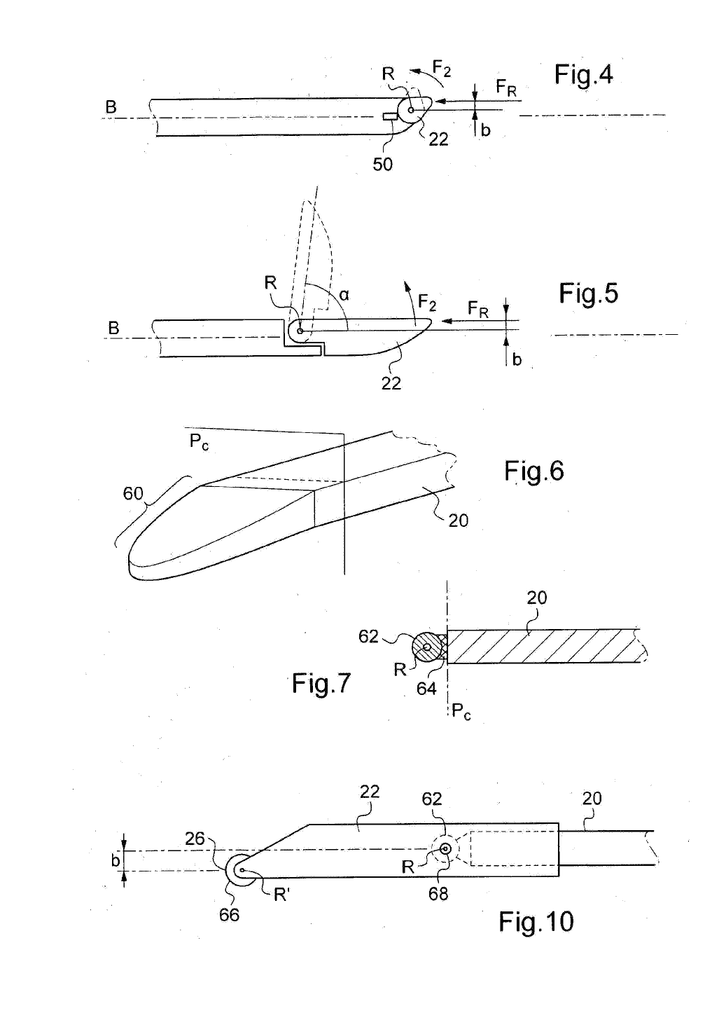

For example, the trigger could have the shape of a rod or a roller (as shown in FIG. 4), preferably rotating on the fork arm about the rotation axis R approximately perpendicular to arm axis B. The shape of the trigger however must be suited to ensure that it can rotate when subjected to a pushing force along the axis of the arm, in other words there is a non-zero lever arm b.

With a trigger having small dimensions, for example a roller, the fork arm preferably has a position change sensor 50.

The trigger 22 may be configured in such a manner as to pivot in a counterclockwise direction when subjected to a pushing force along arm axis B as shown in FIG. 5. Preferably, the angular travel a between the active and passive positions is less than 90°.

Advantageously, the trigger 22 may also return to the passive position under the effect of its own weight. Furthermore, the modification of the fork arm may be limited. In particular, it is not necessary for a flat plate to be provided. In addition, the trigger can only extend on a very reduced part of the total length of the fork. Last in the passive position the trigger may bear a load, for example to serve in transporting a pallet.

In one embodiment, a fork according to the invention has means for controlling the minimum pushing force required to cause the trigger to pivot (when this pushing force is exerted on the outer end of the trigger along the arm axis and toward the fork arm).

This minimum pushing force may be controlled for example by adjusting the friction forces resisting rotation of the trigger on the fork arm, for example in the embodiment of FIG. 8, by tightening or loosening the mounting of rod 68 in holes 69.

The fork preferably comprises means for modifying these friction forces, for example a screw threaded into the trigger and of which one end is supported on the axis of rotation of the trigger on the fork arm.

The means for adjusting the minimum pushing force for pivoting may also comprise an indexing catch, for example, a pin mounted elastically on the trigger and elastically supported on the fork arm in such a manner as to prevent pivoting as long as the pushing force is less than the minimum pushing force for pivoting. The pin may for example be in the passive position pushed by a spring in a hole arranged on a side of the fork arm, the pressure exerted by the spring being insufficient to hold the pin in this hole when the pushing force exceeds the minimum pushing force for pivoting.

Other means to determine the minimum pushing force for pivoting may be conceived, for example a clip that is deactivatable when the pushing force exceeds the minimum pushing force for pivoting.

The minimum pushing force for pivoting may in particular be determined so that the fork arm may be used to pierce plastic film without pivoting the trigger. The number and shape of the roller 66 or the disks 73 are not limiting.

Obviously, the different embodiments described and shown could be combined.

In addition, the detailed description pertains primarily to a forklift; however, the invention also applies to any other material handler equipped with a fork according to the invention.

1. A fork for a handler, the fork comprising:
a fork arm extending along an arm axis, and
a trigger rotatably mounted on the fork arm between passive and active positions, the trigger having an outer end of the trigger defining in the passive position an outer end of the fork, and the trigger being configured in such a manner that a pushing force exerted on the outer end of the trigger along arm axis and toward the fork arm pivots the trigger from the passive position to the active position.

2. The fork according to claim 1, wherein the surface area of the normal projection of the trigger along the arm axis in the active position is at least two times greater than the surface area of the normal projection in the passive position.

3. The fork according to claim 2, wherein the surface area of the normal projection of the trigger along the arm axis in the active position is at least ten times greater than the surface area of the normal projection in the passive position.

4. The fork according to claim 1, wherein the trigger comprises a face whose surface area is greater than 10 cm² and that, in the active position, defines a frontal surface area at the outer end of the fork arm.

5. The fork according to claim 1, configured in such a manner that a pushing force greater than 100 N exerted on the outer end of the trigger, along the arm axis and toward the fork arm, is sufficient to pivot it.

6. The fork according to claim 1, wherein the trigger comprises an outer part extending from the outer end of the trigger to the axis of rotation of the trigger on the fork arm, the outer end of the trigger lying within an axial extension of the fork arm.

7. The fork according to claim 1, wherein the trigger comprises an outer part extending from the outer end of the trigger to the axis of rotation of the trigger on the fork arm, and an inner part extending from the axis of rotation to an inner end of the trigger, the inner part forming a counterweight generating a return moment toward the passive position against a torque generated by the weight of the outer part of the trigger.

8. The fork according to claim 1, wherein the trigger is held in a passive position in the absence of the pushing force by friction or electromagnetism or by an attachment or tie or by adhesive bonding or by its weight or by a counterweight or by an elastic body.

9. The fork according to claim 1, further comprising
stops preventing pivoting of the trigger beyond the active and passive positions.

10. The fork according to claim 1 having no electric parts.

11. The fork according to claim 1, wherein the trigger comprises a body and a roller mounted to rotate freely on the body, the roller defining the outer end of the fork.

12. The fork according to claim 1, further comprising
means for releasing the trigger from the fork arm when a pulling force tending to extend the trigger from the fork arm is exerted, along the arm axis, on the trigger when the trigger is not in a passive position.

13. The fork according to claim 1, further comprising
means for controlling the minimum value of the pushing force necessary for pivoting it.

14. The fork according to claim 1, further comprising
a reader able to read from a distance a label made legible by the reader at the time of pivoting it.

15. A material handler comprising at least one fork according to claim 1.

16. A method of detecting a vertical positioning error of a fork arm of a material handler, the method comprising the step of detecting a change of position of a trigger mounted on the end of the fork arm, rotatable relative to the fork arm and able to pivot under the effect of a pushing force exerted along the axis of the fork arm toward the rear of the material handler.
